(19) United States
(12) Patent Application Publication
(10) Pub. No.: US 2013/0272222 A1
(43) Pub. Date: Oct. 17, 2013

(54) Scheduling Based on UE Probing

(71) Applicants: Johan Hultell, Solna (SE); Johan Bergman, Stockholm (SE); Klas Johansson, Sundbyberg (SE)

(72) Inventors: Johan Hultell, Solna (SE); Johan Bergman, Stockholm (SE); Klas Johansson, Sundbyberg (SE)

(73) Assignee: TELEFONAKTIEBOLAGET L M ERICSSON (PUBL), Stockholm (SE)

(21) Appl. No.: 13/820,587

(22) PCT Filed: Apr. 17, 2012
(86) PCT No.: PCT/SE12/50413

§ 371 Date: Mar. 4, 2013

(51) Int. Cl. H04W 72/04

(52) U.S. Cl. CPC H04W 72/042
USPC 370/329

(57) ABSTRACT

Control of downlink transmissions associated with a first cell (124) in a cellular communication system (100) is described. A plurality of antennas (117) at different locations are configured to transmit downlink signals associated with the first cell. A subset of the plurality of antennas is caused to transmit a respective probing signal intended for reception by a mobile communication terminal (106). Feedback information is received that is indicative of reception in the mobile communication terminal of the probing signals. At least one specific antenna is selected for downlink transmissions to the mobile communication terminal, based at least in part on the feedback information and the at least one specific antenna is caused to perform downlink transmissions to the mobile communication terminal.

### TECHNICAL FIELD

The field of the present disclosure is that of controlling downlink transmissions associated with a cell in a cellular communication system wherein a plurality of antennas at different locations are configured to transmit downlink signals associated with the cell.

### BACKGROUND

Cellular wireless communication systems have evolved from networks in which occasional telephone calls were the dominant type of traffic, into current networks that are required to provide more or less continuous Internet access to a very large and increasing number of users. Needless to say, this means that network operators are constantly in pursuit of extending their networks and enhancing the performance of the nodes in the network, not least the radio access nodes in the form of the radio base stations and nodes that control the radio base stations.

One way to improve the performance of a macro-cellular wireless network is to complement it with additional base stations, possibly with different characteristics (e.g. in in terms of bandwidth, transmit power, noise figure etc.) than existing macro base stations. Herein we will refer to these additional base stations complementing the existing ones as “complementing base stations”. Together the macro and complementing base stations constitute a heterogeneous radio access network.

It is to be noted that many references and examples in the present disclosure refer to a 3rd generation partnership project, 3GPP, universal mobile telecommunication system, UMTS, and particularly to high speed packet access, HSPA, networks. However, this is not to be interpreted as being limiting and the skilled person will readily, without inventive skills, envisage corresponding examples in other similar mobile telecommunication systems.

Complementing base stations can be deployed for improving radio coverage of the network, in which case the complementing base stations are deployed in areas where the existing macro base stations provide poor coverage (e.g., shielded indoor locations).

Complementing base stations can also be deployed for increasing capacity, in which case the complementing base stations are deployed in areas where there is a high local traffic demand (“traffic hotspot”). This means that a significant proportion of the traffic is constrained within a limited geographical area.

As the traffic volumes and data rates increase, the initial deployment of macro base stations is often not sufficient to meet the users' data rate requirements. Therefore, to ensure a sufficient service quality with wide area coverage, the network may need to be complemented with additional base stations. If the “coverage hole” (i.e. area where the coverage is poor) is local, or finding new base station site locations for macro base stations is difficult, it may be more cost efficient to deploy a complementing base station than deploying a full-feathered macro base station.

If the new, complementing base station is deployed as a separate cell (i.e. with a unique cell id, scrambling code, etc.) this requires that the cell plan (e.g., neighbor cell list, NCL) is updated. Furthermore, if the transmit power is different from the surrounding cells a suitable cell individual offset, CIO, for handover measurements needs to be selected. Also, the introduction of new cells will lead to an increased radio network controller, RNC, load since mobility events such as serving cell changes need to be reported more frequently. Hence, adding new unique cells may be a rather cumbersome task.

An alternative to adding a new unique cell would be to let the complementing base stations transmit the same physical signals as the macro base stations and thereby forming, together with the macro base station, what can be regarded as a shared cell. For wideband code division multiple access, WCDMA, high speed downlink packet access,

HSDPA, networks this would implicate that the complementing base stations use the same downlink scrambling code and carrier frequency as the macro base station. In such an alternative, the combined signal received in a mobile communication terminal or user equipment, UE, from the macro and complementing base stations will look as one signal transmitted with a higher power (i.e. the total combined power of the macro base stations and the complementing base station(s)) through a different radio multi-path channel. This allows that all existing procedures such channel quality indicator, CQI, reporting and mobility event handling can be reused.

While this approach may be useful in contexts where the objective is to increase downlink coverage for the UEs in the area where the additional base stations are deployed this may come at the expense of overall reduced downlink capacity. This is because all antennas transmit the same data (at a given time instance), which will result in an increased interference level.

Another alternative for increasing downlink capacity and coverage is, as briefly touched upon above, to operate the complementing base stations and the macro base station as separate cells with different scrambling codes. This would allow that one UE is connected to (and receives data from) the macro base station while another UE at the same time receives data from the complementing base station. This approach will increase the downlink capacity. At the same time though the RNC load will increase proportionally with the number of complementing base stations, as mentioned above.

Which of these two approaches for increasing downlink capacity and coverage that is most suitable is context-dependent and it will most likely vary over time. For example, when starting to offer mobile broadband services it is likely so that an existing network is too sparse for offering sufficient data rates over the entire area even though the load is small (due to the initial small uptake of new services). In this situation it would be suitable to deploy complementing base stations as “gap fillers” (i.e. operate them with the same scrambling code). As the uptake increases, the network will go from being coverage limited to becoming capacity limited. In order to increase capacity, the operation of some of the complementing base stations could be changed so that they are operated as unique cells. Where exactly this transition occurs depends on how efficiently complementing base stations can be used when they are reusing the scrambling code of the macro base station, i.e. when they are used as gap-fillers.

Obviously it is important to ensure that the network resources are efficiently used in contexts where the complementing base stations have been deployed as gap-fillers and the macro and complementing base station is operated as a shared cell.

An architecture where the macro base station and the complementing base stations covering the same geographical area are operated as a shared cell has drawbacks. Since more base stations transmit all the physical downlink signals (in the same geographical area) more downlink inter-cell interference will be generated. The increased inter-cell interference levels will result in reduced signal to interference ratio, SIR, levels in the neighboring cells. The magnitude of this problem will increase as the relative number of complementing base stations increases.

Furthermore, the efficiency of interference suppressing Type 3i UE receivers in neighboring cells (using a different scrambling code) may be reduced since UEs will see multiple spatially separated interference sources.

Also, the available power resources in the shared cell may be used inefficiently. This is because also base stations with a very weak link to the UE will transmit physical data channels to the UE. Due to the inter-cell interference generated from these base stations the overall net contribution on a system performance from these transmissions may be negative (i.e. the transmissions cause more harm to other UEs than benefit to the UE being scheduled).

For all these reasons it would be desirable to only transmit downlink physical signals to a certain UE if the path gain between the physical antenna and the UE is sufficiently high, such that the transmitter significantly contributes to the total receive signal. To some extent this could be achieved by monitoring uplink signal power (for example dedicated physical control channel, DPCCH, received signal code power, RSCP). A weak uplink signal would be an indication of that the downlink path gain is weak, and therefore it may make sense to avoid downlink transmission from base stations/antennas where the detected uplink signal is weak. However, in practice the base stations will have a limited sensitivity and dynamic range. This means that the range of received power that can be detected in the uplink is limited. While this potentially may not be a problem when all base stations that are operated as a shared cell use the same downlink transmission power, the approach could be problematic when there is an asymmetry in downlink transmission power associated with the antennas/base stations in the shared cell. An example scenario is one where one macro and one complementing base station are involved and the macro base station transmits with a significantly higher transmit power. In this case it could be so that the UE is power controlled towards the complementing base station and that the transmit power used by the UE is so small so that the uplink DPCCH cannot be detected at the macro base station (due to the limited dynamic range). However, since the macro base station transmits at a significantly higher transmit power it may still be so that transmission from the macro base station has significant impact on the performance measured by the UE.

### SUMMARY

In order to mitigate at least some of the drawbacks as discussed above, there is provided in a first aspect a method of controlling downlink transmissions associated with a first cell in a cellular communication system. A plurality of antennas at different locations are configured to transmit downlink signals associated with the first cell. The method comprises causing a subset of the plurality of antennas to transmit a respective probing signal intended for reception by a mobile communication terminal. Feedback information is received that is indicative of reception in the mobile communication terminal of the probing signals. At least one specific antenna is selected for downlink transmissions to the mobile communication terminal, based at least in part on the feedback information and the at least one specific antenna is caused to perform downlink transmissions to the mobile communication terminal.

The antennas that are configured to transmit downlink signals can be configured to transmit code division signals having one and the same scrambling code and carrier frequency.

In other words, a method is provided whereby the network can identify one or more antennas among the plurality of antennas wherefrom downlink transmissions should take place. This is accomplished by transmission of a probing-signal from one or more antennas among the plurality of antennas. Based on feedback provided by the UE to the network, the antennas wherefrom the transmission has occurred are categorized as being within or outside a reception domain of the UE and thereby being suitable to use for downlink transmissions.

Embodiments of the present disclosure offer advantages such as enabling increased cell throughput and efficient use of the network resources. Reduced interference may also be obtained and the performance of the UE receiver can be improved while at the same time reducing the load on network nodes such as RNCs.

Furthermore, in a high speed downlink packet access, HSDPA, network, an advantageous effect of controlling transmissions from one or more selected antenna as summarized above is that it becomes known from which antennas other HSDPA transmissions can be done to other UEs. That is, transmissions to other UEs than the UE that is the recipient of the transmissions from the selected one or more antennas, without interfering that particular UE too much. Normally it is not possible to do HSDPA transmissions to different UEs at the same time within a cell using the same HSDPA resources (i.e. the same high speed physical downlink shared channel, HS-PDSCH, codes), but with a sensible antenna selection it is possible.

The method can comprise evaluating a triggering condition that causes the subset of antennas to transmit a respective probing signal. For example, the triggering condition can be any one of:
a signal received from the mobile communication terminal has a Doppler spread that is higher than a Doppler spread threshold,
signals received at different instants in time from the mobile communication terminal have signal power levels that differ by an amount that is larger than a signal power difference threshold,
signals received at different instants in time from the mobile communication terminal have signal qualities that differ by an amount that is larger than a signal quality difference threshold,
a data transmission load for the subset of antennas is above a first data transmission load threshold,
a spatial distance between the mobile communication terminal and an antenna is less than a threshold distance,
a timer expiry, or
a detection that the mobile communication terminal has switched from a first operational state to a second operational state.

The probing signal can comprise a high speed shared control channel, HS-SCCH, order.

The probing signal can comprise a high speed shared control channel, HS-SCCH, data associated transmission. In such cases, the probing signal can further comprise a high speed physical downlink shared channel, HS-PDSCH, transmission.

The feedback information indicative of reception in the mobile communication terminal can comprise a hybrid automatic repeat request, HARQ, acknowledgement or non-acknowledgement, ACK/NACK, indication.

In cases where HS-PDSCH transmission takes place, a further triggering condition is an error probability associated with the HS-PDSCH transmission is higher than an error probability threshold.

The steps of causing a subset of the plurality of antennas to transmit a respective probing signal, receiving feedback information and selecting at least one specific antenna for downlink transmissions can be performed in an iteration procedure. Each iteration involves a current subset of antennas that comprises at least one antenna that is not present in a previous subset of antennas. This iteration can be interrupted the first time the at least one antenna is selected for downlink transmissions.

In a second aspect there is provided an apparatus for controlling downlink transmissions associated with a first cell in a cellular communication system. A plurality of antennas at different locations are configured to transmit downlink signals associated with the first cell. The apparatus comprises control circuitry for causing a subset of the plurality of antennas to transmit a respective probing signal intended for reception by a mobile communication terminal, feedback reception circuitry for receiving feedback information indicative of reception in the mobile communication terminal of the probing signals, selection circuitry for selecting, based at least in part on the feedback information, at least one specific antenna for downlink transmissions to the mobile communication terminal, and control circuitry for causing the at least one specific antenna to perform downlink transmissions to the mobile communication terminal.

In a third aspect there is provided a computer program product comprising software instructions that are configured, when executed in a processing device, to perform the method of the first aspect.

The effects and advantages of the second aspect and the third aspect correspond to those summarized above in connection with the first aspect.

### BRIEF DESCRIPTION OF THE DRAWINGS

FIG. 1 illustrates schematically a mobile communication system,

FIGS. 2a and 2b illustrate schematically functional block diagrams of an apparatus for controlling transmissions in a mobile communication system,

FIG. 3 is a flow chart of a method for controlling transmissions in a mobile communication system, and

FIG. 4 is a flow chart of a method for controlling transmissions in a mobile communication system.

### DETAILED DESCRIPTION

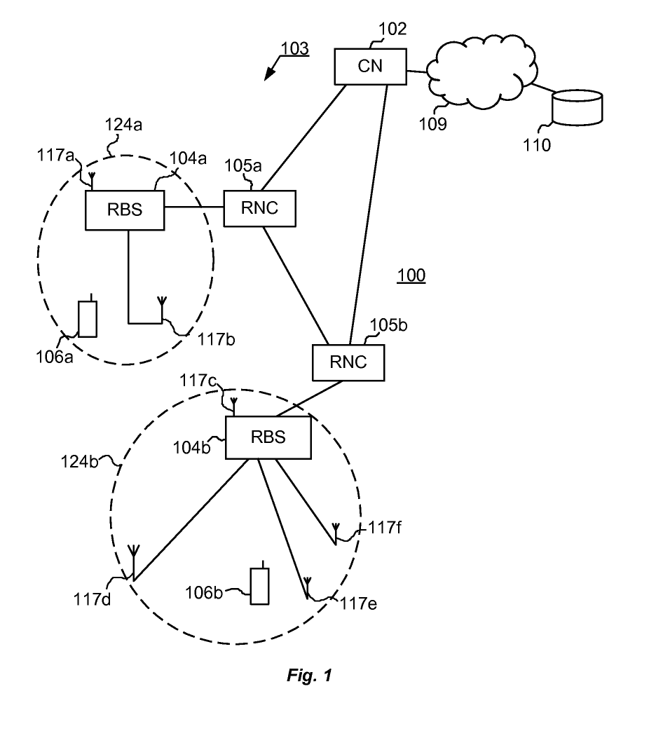

FIG. 1 illustrates schematically a cellular communication system 100, for example a universal mobile telecommunications system, UMTS, network in which the present methods and apparatuses can be implemented. It should be noted that, even if references and examples in the following description relate to UMTS systems, the skilled person will readily be able to perform implementations in other similar communication systems involving transmission of coded data between nodes.

In FIG. 1 the communication system 100 comprises a core network 102 and a terrestrial radio access network 103, for example a universal terrestrial radio access network, UTRAN. The radio access network 103 comprises a number of nodes in the form of radio network controllers 105a, 105b each of which is coupled to nodes in the form of one or more radio base stations, 104a, 104b. Each radio base station is responsible for a respective radio cell 124a, 124b and radio signals are transmitted and received in the cells via antennas 117a-b (for radio base station 104a) and antennas 117c-f (for radio base station 104b). The radio network controllers 105 are responsible for routing user and signaling data between the radio base stations 104 and the core network 102. All of the radio network controllers 105 are coupled to one another. A general outline of a UTRAN radio access network 103 is given in 3GPP technical specification TS 25.401 V10.2.0.

FIG. 1 also illustrates communicating entities in the form of mobile communication terminals or user equipment, UE, 106a, 106b in the radio cells 124a,b. The core network 102 comprises a number of nodes, as the skilled person will realize and omitted in FIG. 1 for the sake of clarity, and provides communication services to the UEs 106 via the radio access network 103, for example when communicating with the Internet 109 where, schematically, a server 110 illustrates an entity with which the UEs 106 can communicate. As the skilled person realizes, the network 100 in FIG. 1 may comprise a large number of similar functional units in the core network 102 and the radio access network 103, and in typical realizations of networks, the number of mobile devices may be very large.

Furthermore, as discussed herein, communication between the nodes in the radio access network 103 and the UEs 106 may follow the protocols as specified by 3GPP HSPA specifications.

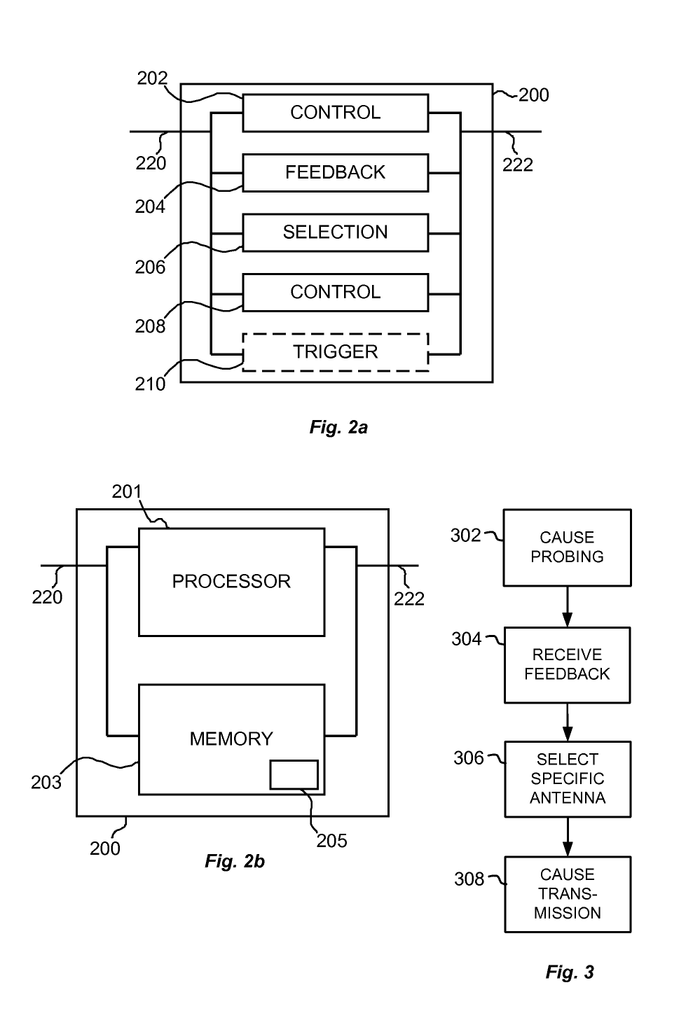

Turning now to FIGS. 2a, 2b and 3 and with continued reference to FIG. 1, examples of an apparatus and a method for controlling downlink transmissions will be described.

FIG. 2a is a functional block diagram that illustrates an apparatus 200 that is configured to operate in a radio access network, such as the radio access network 103 in FIG. 1. In the example of FIG. 2, the apparatus 200 comprises circuitry that can form part of a radio base station, such as any of the radio base stations 104 in FIG. 1, and connection with radio receiver/transmitter circuitry and other circuitry of such a radio base station is by means of an input connection 220 and an output connection 222.

The circuitry in the apparatus 200 is configured to control downlink transmissions associated with a cell in a cellular communication system, such as the system 100 in FIG. 1, wherein a plurality of antennas at different locations are configured to transmit downlink signals associated with the cell. For example, in a case where the communication system is a WCDMA HSDPA system, the cell is defined by the antennas that use one and the same scrambling code and downlink carrier frequency for transmission.

FIG. 3 is a flow chart that illustrates method steps corresponding to the functions provided by the apparatus circuitry. Specifically, the apparatus 200 comprises probing control circuitry 202, feedback reception circuitry 204, antenna selection circuitry 206 and downlink control circuitry 208. Probing trigger circuitry 210 can also form part of the apparatus.

The control circuitry 202 is configured such that it causes a subset of the plurality of antennas to transmit a respective probing signal intended for reception by a mobile communication terminal. A method step 302 illustrates this in FIG. 3.

For example, the downlink transmission of the probing signal can be realized in the form of an HS-SCCH order. The first HS-SCCH orders were introduced in WCDMA/HSPA in the 3GPP Release 7 specifications.

In other examples, the downlink transmission of the probing signal can be realized in the form of an ordinary data-associated HS-SCCH transmission. In such cases, the HS-SCCH transmission can be accompanied by an HS-PDSCH transmission as is normally the case in HSDPA operation since 3GPP specifications Release 5, or the HS-SCCH transmission can occur without an accompanied HS-PDSCH transmission.

Due to the fact that 3GPP Release 5 UEs and Release 6 UEs do not support HS-SCCH orders, examples include those where HS-SCCH orders are used for newer UEs that support HS-SCCH orders and use of ordinary data-associated HS-SCCH transmission for older UEs that do not support HS-SCCH orders.

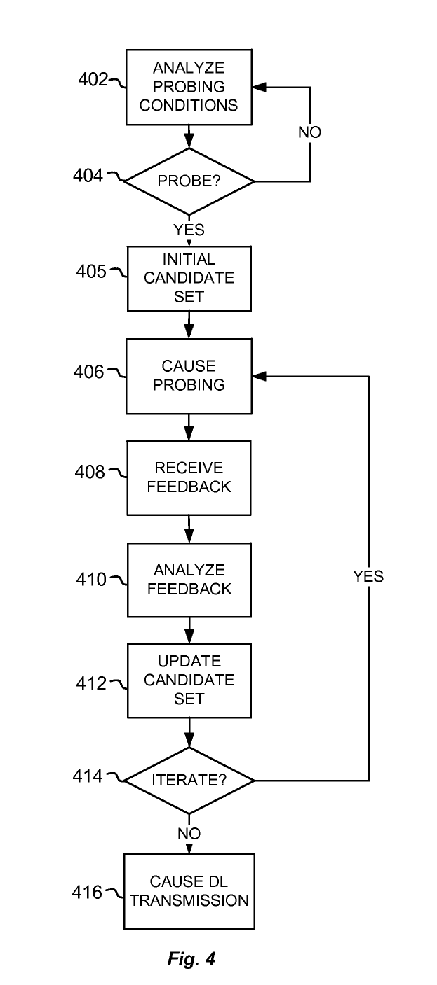

The transmission of the probing downlink signal can take place in a sequential manner from each of the individual antennas in the subset of antennas. In other words, in sub-frame i transmissions occur from antenna j, in sub-frame i+1 transmissions occur from antenna j+1, etc. Examples of selecting the subset of antennas to be caused to transmit the probing signals will be described below in connection with FIG. 4.

The feedback reception circuitry 204 is configured such that it receives 304 feedback information indicative of reception in the mobile communication terminal of the probing signals. A method step 304 illustrates this in FIG. 3.

For example, the UE can respond in the following way on the feedback channel HS-DPCCH that is transmitted in the uplink:

In examples where the probing signal is in the form of an HS-SCCH order and the UE is able to detect the HS-SCCH order, the UE will respond with positive HARQ acknowledgment (HARQ-ACK) transmission on the HS-DPCCH.

In examples where the probing signal is in the form of a data-associated HS-SCCH without any accompanying HS-PDSCH transmission, and the UE is able to detect the HS-SCCH, the UE will respond with a negative HARQ acknowledgment (HARQ-NACK) transmission on the HS-DPCCH since the UE cannot successfully decode the non-existent data.

In examples where the probing signal is in the form of a data-associated HS-SCCH accompanied by an HS-PDSCH transmission, and the UE is able to detect the HS-SCCH, the UE will respond with either a positive or a negative HARQ acknowledgment (HARQ-ACK/NACK) transmission on HS-DPCCH depending on whether the UE was able to decode the data successfully or not.

If the UE does not detect the HS-SCCH or HS-SCCH order, it will not send any HARQ-ACK/NACK on the HS-DPCCH.

It shall be noted that even though the HS-SCCH transmission only takes place from a subset of the antennas, feedback from the UE on the uplink HS-DPCCH can in principle be received by antennas that are not used for the transmission of the probing signals.

The selection circuitry 206 is configured such that it selects 306, based at least in part on the feedback information, at least one specific antenna for downlink transmissions to the mobile communication terminal. A method step 306 illustrates this in FIG. 3.

The control circuitry 208 is configured such that it causes 308 the at least one specific antenna to perform downlink transmissions to the mobile communication terminal. A method step 308 illustrates this in FIG. 3.

The trigger circuitry 210, if present, is configured to trigger the control circuitry 202 to cause the transmission of the probing signals, as will be discussed in some more detail below in connection with FIG. 4.

As the skilled person will realize, and with reference to FIG. 2b, the circuitry blocks of the apparatus 200 can also be represented in the form of an apparatus comprising a processor 201 and memory circuits 203 that, when suitably programmed with software instructions 205 representing the method steps of FIG. 3, performs the method steps of FIG. 3.

Turning now to FIG. 4, and with continued reference also to FIGS. 1 and 2, further examples of controlling downlink transmissions will be described.

FIG. 4 is a flow chart that illustrates method steps corresponding to the functions provided by an apparatus that can be the apparatus 200 of FIG. 2. As for the example in FIG. 2, an apparatus that realizes the method steps of FIG. 4 comprises circuitry that can form part of a radio base station, such as any of the radio base stations 104 in FIG. 1.

The method commences with a decision process comprising an analysis step 402 and a decision step 404. The decision to take in this decision process is whether or not to start a probing procedure such as the probing procedure described above in connection with FIG. 3. In other words, this decision process can be regarded as a procedure that triggers the execution of a probing procedure for a specific UE because the analysis step 402 comprises analysis of triggering conditions.

For example, one triggering condition can be that of estimated Doppler spread associated with the UE. A high Doppler spread can be viewed as an indication of high UE mobility in which case it may be beneficial to start the probing procedure and/or perform the probing procedure more frequently than for low-mobility UEs. The Doppler spread estimate can thus be used to set the frequency of the probing procedure.

Another example of a triggering condition is based on uplink measurements. For example, if the RSCP and/or estimated SIR associated with the mobile communication terminal and the different antennas changes this can be viewed as an indication that the path gain associated with the different antennas has changed.

Another example of a triggering condition is based on the load associated with the antennas. That is, a triggering condition can be that a data transmission load for the subset of antennas is high, e.g. above a data transmission load threshold. In cases where the load of the cell (and possibly also the load of neighbouring cells) is low, e.g. below a threshold, probing may not be needed and data transmissions can occur from all antennas configured to transmit downlink signals associated with the cell. That is, complexity and signalling overhead may be reduced by only applying the probing to UEs with larger amounts of downlink traffic.

Another example of a triggering condition is based on the error probability associated with HS-PDSCH transmissions, which is known via HARQ-ACK/NACK messages transmitted from the mobile communication terminal on HS-DPCCH. For example, if the error probability significantly exceeds the block error rate, BLER, target this can be viewed as an indication of that the set of physical antennas wherefrom transmissions occur is suboptimal.

Another example of a triggering condition is based on positioning information. Through location information the whereabouts of complementing base stations can be correlated with user position and if it is found that the UE is geographically close to a complementing base station antenna, it can be beneficial to initiate probing using at least this closely located antenna.

Another example of a triggering condition is based on expiration of a timer. That is, the probing procedure can be controlled to be performed every X seconds, where X is a reasonable number depending on the implementation.

Another example of a triggering condition is based on a detection that the mobile communication terminal has switched from a first operational state to a second operational state. For example, in WCDMA/HSPA systems, when the mobile communication terminal enters the CELL_DCH state, in which immediate reception of user data is possible via the HS-DSCH channel, probing can be done. However, the probing procedure can be controlled to be performed after some or all possible transitions between IDLE state, URA_PCH state, CELL_PCH state, CELL_FACH state and the CELL_DCH state.

A determination of which antennas are to be used in the probing procedure, i.e. a determination of an initial candidate set of antennas, is made in an initial candidate set step 405. For example, the initial candidate set of antennas can be one or more of all antennas that are configured to transmit downlink signals associated with the cell.

When a candidate set of antennas has been determined and a decision has been taken in the decision process 402, 404, probing signals are caused to be transmitted in a transmission step 406. The probing signals are transmitted from the antennas in the candidate set in the manner already described above in connection with FIG. 3.

Feedback is received from the UE in a reception step 408 and analysed in an analysis step 410 in the manner already described above in connection with FIG. 3. However, in addition to the straight-forward way in which the selection of antenna is made in the method of FIG. 3, the analysis step 410 provides a basis for a decision whether or not to modify the candidate set of antennas from which the probing signals are transmitted and iterate the probing procedure with a modified candidate set.

This is realized in an update step 412 and a decision step 414, where the candidate set is modified in accordance with the results of the feedback analysis in step 410. Depending on how the initial candidate set is composed, the modification of the candidate set can be realized in different ways. For example, a so-called round robin scheme can be used where each antenna configured to transmit downlink signals associated with the cell is used one after one, i.e. the candidate set is a single antenna for each iteration. Another example is to use an initial candidate set that consists of a first half of the antennas configured to transmit downlink signals associated with the cell, perform the probing procedure and then iterate with a modified candidate set that consists of a second half of the antennas in. If the analysis of the feedback is positive (cf. the feedback discussion related to FIG. 3) for one of the halves, this half is then subject to the iteration and modified into two halves in a similar manner.

If it is decided in the decision step 414 not to modify the candidate set of antennas, i.e. if the analysis of the feedback in analysis step 410 has provided an output that is positive in terms of a suitable set of at least one antenna to use for downlink transmissions, transmission on the downlink is caused in a transmission step 416 as described above in connection with FIG. 3.

Typically, when implementing the above examples in a WCDMA/HSDPA system, all antennas in a cell that are switched on will transmit at least the common pilot channel, CPICH, and possibly also most other common downlink physical channels such as the synchronization channel, SCH, and one or more primary/secondary common control physical channels, P/S-CCPCH (see section 5.3.3 in 3GPP TS 25.211 for the full list of common downlink physical channels).

However, the HSDPA-related downlink physical channels HS-SCCH and HS-PDSCH are the ones that are of more interest in these examples and these are transmitted only from the antennas that the UE can receive well. This is where the control method and apparatus described above helps a base station, e.g. a NodeB, to find out from which antennas a particular UE can receive an HSDPA transmission with decent quality and to select these antennas for HSDPA transmission to that particular UE. It can be noted that a side effect of this is that a NodeB will know from which antennas the NodeB can safely do other HSDPA transmissions to other UEs without interfering that particular UE too much. Normally it is not possible to perform HSDPA transmissions to different UEs at the same time within a cell using the same HSDPA resources (i.e. the same HS-PDSCH codes), but with a sensible antenna selection it is possible.

It also makes sense to transmit dedicated downlink physical channels intended for the particular UE from the same antennas as the above mentioned HSDPA transmissions. These dedicated channels include, e.g., the E-DCH hybrid ARQ indicator channel, (E-HICH, and the fractional dedicated physical channel, F-DPCH, see section 5.3.2 in 3GPP TS 25.211 for the full list of dedicated downlink physical channels.

1-23. (canceled)

24. A method of controlling downlink transmissions associated with a first cell in a cellular communication system wherein a plurality of antennas at different locations are configured to transmit downlink signals associated with the first cell, the method comprising:
causing a subset of the plurality of antennas to transmit respective probing signals intended for reception by a mobile communication terminal;
receiving feedback information indicative of reception in the mobile communication terminal of the probing signals;
selecting, based at least in part on the feedback information, at least one specific antenna for downlink transmissions to the mobile communication terminal; and
causing the at least one specific antenna to perform downlink transmissions to the mobile communication terminal.

25. The method of claim 24, wherein the plurality of antennas that are configured to transmit downlink signals are configured to transmit code division signals having one and the same scrambling code and carrier frequency.

26. The method of claim 24, further comprising evaluating a triggering condition, wherein the causing of a subset of the antennas to transmit a respective probing signal is in response to said evaluating of the triggering condition.

27. The method of claim 26, wherein the triggering condition is any one of:
a signal received from the mobile communication terminal having a Doppler spread that is higher than a Doppler spread threshold;
signals received at different instants in time from the mobile communication terminal having signal power levels that differ by an amount that is larger than a signal power difference threshold;
signals received at different instants in time from the mobile communication terminal having signal qualities that differ by an amount that is larger than a signal quality difference threshold;
a data transmission load for the subset of antennas being above a first data transmission load threshold;
a spatial distance between the mobile communication terminal and an antenna being less than a threshold distance;
a timer expiry; or
a detection that the mobile communication terminal has switched from a first operational state to a second operational state.

28. The method of claim 24, wherein the probing signal comprises a high speed shared control channel (HS-SCCH) order.

29. The method of claim 28, wherein the feedback information indicative of reception in the mobile communication terminal comprises a hybrid automatic repeat request (HARD) acknowledgement or non-acknowledgement (ACK/NACK) indication.

30. The method of claim 24, wherein the probing signal comprises a high speed shared control channel (HS-SCCH) data associated transmission.

31. The method of claim 30, wherein the probing signal further comprises a high speed physical downlink shared channel (HS-PDSCH) transmission.

32. The method of claim 31, further comprising the triggering condition:
an error probability associated with the HS-PDSCH transmission being higher than an error probability threshold.

33. The method of claim 24, wherein the step of causing a subset of the plurality of antennas to transmit a respective probing signal, the step of receiving feedback information and the step of selecting at least one specific antenna for downlink transmissions are performed in an iteration procedure, each iteration involving a current subset of antennas that comprises at least one antenna that is not present in a previous subset of antennas.

34. The method of claim 33, wherein the iteration procedure is interrupted the first time the at least one antenna is selected for downlink transmissions.

35. An apparatus for controlling downlink transmissions associated with a first cell in a cellular communication system wherein a plurality of antennas at different locations are configured to transmit downlink signals associated with the first cell, the apparatus comprising:
control circuitry configured to cause a subset of the plurality of antennas to transmit respective probing signals intended for reception by a mobile communication terminal;
feedback reception circuitry configured to receive feedback information indicative of reception in the mobile communication terminal of the probing signals;
selection circuitry configured to select, based at least in part on the feedback information, at least one specific antenna for downlink transmissions to the mobile communication terminal; and
control circuitry configured to cause the at least one specific antenna to perform downlink transmissions to the mobile communication terminal.

36. The apparatus of claim 35, wherein the plurality of antennas that are configured to transmit downlink signals are configured to transmit code division signals having one and the same scrambling code and carrier frequency.

37. The apparatus of claim 35, further comprising trigger evaluation circuitry configured to evaluate a triggering condition, wherein the control circuitry configured to cause a subset of the plurality of antennas to transmit a respective probing signal is further configured to cause transmission of the probing signals in dependence on the triggering condition.

38. The apparatus of claim 37, wherein the triggering condition is any one of:
a signal received from the mobile communication terminal having a Doppler spread that is higher than a Doppler spread threshold;
signals received at different instants in time from the mobile communication terminal having signal power levels that differ by an amount that is larger than a signal power difference threshold;
signals received at different instants in time from the mobile communication terminal having signal qualities that differ by an amount that is larger than a signal quality difference threshold;
a data transmission load for the subset of antennas being above a first data transmission load threshold;
a spatial distance between the mobile communication terminal and an antenna being less than a threshold distance;
a timer expiry; or
a detection that the mobile communication terminal has switched from a first operational state to a second operational state.

39. The apparatus of claim 35, wherein the probing signal comprises a high speed shared control channel (HS-SCCH) order.

40. The apparatus of claim 39, wherein the feedback information indicative of reception in the mobile communication terminal comprises a hybrid automatic repeat request (HARQ) acknowledgement or non-acknowledgement (ACK/NACK) indication.

41. The apparatus of claim 35, wherein the probing signal comprises a high speed shared control channel (HS-SCCH) data associated transmission.

42. The apparatus of claim 41, wherein the probing signal further comprises a high speed physical downlink shared channel (HS-PDSCH) transmission.

43. The apparatus of claim 42, wherein the trigger evaluation circuitry is further configured to evaluate the triggering condition:
an error probability associated with the HS-PDSCH transmission is higher than an error probability threshold.

44. The apparatus of claim 35, wherein the control circuitry configured to cause a subset of the plurality of antennas to transmit a respective probing signal, the feedback reception circuitry and the selection circuitry are configured to perform an iteration procedure, each iteration involving a current subset of antennas that comprises at least one antenna that is not present in a previous subset of antennas.

45. The apparatus of claim 44, configured such that the iteration procedure is interrupted the first time the at least one antenna is selected for downlink transmissions.

46. A non-transitory computer-readable medium comprising software instructions stored thereupon, wherein said software instructions are configured such that, when executed in a processor associated with a first cell in a cellular communication system wherein a plurality of antennas at different locations are configured to transmit downlink signals associated with the first cell, cause the processor to:
cause a subset of the plurality of antennas to transmit respective probing signals intended for reception by a mobile communication terminal;
receive feedback information indicative of reception in the mobile communication terminal of the probing signals;
select, based at least in part on the feedback information, at least one specific antenna for downlink transmissions to the mobile communication terminal; and
cause the at least one specific antenna to perform downlink transmissions to the mobile communication terminal.
